(19) United States
(12) Patent Application Publication
(10) Pub. No.: US 2026/0223216 A1
(43) Pub. Date: Jul. 30, 2026

(54) METHOD AND APPARATUS FOR INTEGRATED DISCOVERY SUPPORT WITH UE-TO-UE RELAY

(71) Applicant: InterDigital Patent Holdings, Inc., Wilmington, DE (US)

(72) Inventors: Jung Je Son, Warrington, PA (US); Michelle Perras, Montreal (CA); Samir Ferdi, Kirkland (CA); Taimoor Abbas, Sainte-Julie (CA)

(21) Appl. No.: 19/145,723

(22) PCT Filed: Dec. 28, 2023
(86) PCT No.: PCT/US2023/086164

§ 371 Date: Jul. 3, 2025

Related U.S. Application Data
(60) Provisional application No. 63/436,736, filed on Jan. 3, 2023.
(60) Provisional application No. 63/444,460, filed on Feb. 9, 2023.

(51) Int. Cl. H04W 76/14; H04W 88/04; H04W 92/18

(52) U.S. Cl. CPC H04W 76/14; H04W 88/04; H04W 92/18

(57) ABSTRACT

In an embodiment, a method, implemented in a first wireless transmit/receive unit, WTRU, to perform integrated discovery when there is an existing sidelink connection between the first WTRU or a second WTRU and at least one WTRU-to-WTRU relay, comprising transmitting, to the second WTRU, via the at least one WTRU-to-WTRU relay, a direct communication request message comprising proximity-based service parameters; receiving, from the second WTRU, via one of the at least one WTRU-to-WTRU relay, a link modification request message comprising information related to the proximity-based service parameters; transmitting, to the one of the at least one WTRU-to-WTRU relay, a link modification response; and receiving, from the one of the at least one WTRU-to-WTRU relay, a direct communication accept message.

### CROSS-REFERENCE TO RELATED APPLICATIONS

The present application claims the benefit of U.S. Provisional Patent Application No. 63/436,736 filed Jan. 3, 2023, and U.S. Provisional Patent Application No. 63/444,460 filed Feb. 9, 2023, each of which are incorporated herein by reference in its entirety.

### FIELD OF THE INVENTION

The present disclosure is generally directed to the fields of communications, software and encoding, including, for example, to methods, architectures, apparatuses, systems directed to integrated discovery support with user equipment to user equipment (UE-to-UE) relay.

### BACKGROUND

For discovery integrated into PC5 unicast link establishment (so called integrated discovery), a source user equipment (source UE) may send a direct communication request (DCR) message in broadcast without selecting a user equipment to user equipment relay (UE-to-UE relay) such that many UE-to-UE relays may send/forward the DCR to a target UE. After sending/forwarding the DCR message, each UE-to-UE relay may expect a response from the target UE with a direct communication accept (DCA) message. After receiving the DCA message, one UE-to-UE relay may respond/forward to the source UE with the DCA message.

However, PC5 link sharing should be used. More particularly, when there is (e.g., already) an existing PC5 connection between an end user equipment (end UE) and a UE-to-UE relay, the existing PC5 link should be reused (e.g., using link modification procedure) instead of establishing new PC5 links.

Furthermore, when a source UE uses service oriented PC5 link setup (e.g., target UE user information not included in DCR message), the UE-to-UE relay has no information about the potential target UE the source UE may communicate with.

In protocol perspective, race condition may happen between DCR message/DCA message and link modification procedure which needs to be resolved. For example, the UE-to-UE relay may receive a DCR message from a source UE which triggers sending the DCR to a target UE, which replies by either sending a DCA message or by initiating the link modification procedure. Similarly, the UE-to-UE relay may reply to the source UE by sending a DCA message or by initiating the Link Modification procedure.

Therefor it has to be clarified how UE-to-UE relay will be triggered to send a response to a source UE including a DCA message when link modification is used with a target UE and how the source UE will determine if the DCR message is responded when link modification procedure is performed between UE-to-UE relay and the source UE.

In addition, for layer-3 (L3) relay case, end-to-end quality of service (QoS) may be requested by a source UE and QoS for each PC5 connection may be determined by UE-to-UE relay. For integrated discovery case it shall be clarified how PC5 QoS is setup.

There is a need for defining PC5 link establishment procedure between two end UEs, via a UE-to-UE Relay, when integrated discovery is used.

### SUMMARY

In an embodiment, a method, implemented in a first wireless transmit/receive unit (WTRU) to perform integrated discovery when there is an existing sidelink connection between the first WTRU or a second WTRU and at least one WTRU-to-WTRU relay, may comprise a step of transmitting, to the second WTRU, via the at least one WTRU-to-WTRU relay, a direct communication request (DCR) message comprising proximity-based service (ProSe) parameters. The method may further comprise a step of receiving, from the second WTRU, via one of the at least one WTRU-to-WTRU relay, a link modification request message comprising information related to the ProSe parameters. The method may further comprise a step of transmitting, to the one of the at least one WTRU-to-WTRU relay, a link modification response message; and a step of receiving, from the one of the at least one WTRU-to-WTRU relay, a direct communication accept (DCA) message.

In another embodiment, a method, implemented in a WTRU-to-WTRU relay, may comprise a step of receiving, from a first WTRU, a DCR message comprising information including quality of service (QoS) information related to a proximity-based service. The method may further comprise a step of determining first values of QoS parameter for the link between the first WTRU and the WTRU-to-WTRU relay. The method may further comprise a step of transmitting, to a second WTRU, the DCR message. The method may further comprise a step of receiving, from the second WTRU, second values of QoS parameters for the link between the second WTRU and the WTRU-to-WTRU relay; and a step of determining whether a direct communication between the first and the second WTRU is accepted based on the first values of QoS parameters and the second values of QoS parameters.

In another embodiment, a method implemented in a wireless transmit/receive unit, WTRU, to perform integrated discovery may comprise a step of receiving from each WTRU-to-WTRU relay of a first set of WTRU-to-WTRU relays, a direct communication request message including a first communication request from a first source WTRU. The method may comprise a step of receiving from each WTRU-to-WTRU relay of a second set of WTRU-to-WTRU relays, a link modification request message including a second communication request from the first source WTRU. The method may comprise a step of selecting a WTRU-to-WTRU relay among the first and second set of WTRU-to-WTRU relays for communication with the first source WTRU; and a step of transmitting link modification reject messages to all WTRU-to-WTRU relays of the second set of WTRU-to-WTRU relays not selected for communication with the source WTRU.

On condition that the selected WTRU-to-WTRU relay is from the first set of WTRU-to-WTRU relays and an existing sidelink connection between the WTRU and the selected WTRU-to-WTRU relay is already established, the method may comprise a step of transmitting a direct communication reject message to the selected WTRU-to-WTRU relay. The method may comprise a step of comprising performing a link modification procedure with the selected WTRU-to-WTRU relay for modifying the existing sidelink connection. The step of selecting a WTRU-to-WTRU relay may comprise a step of selecting, among the first and second sets of WTRU-to-WTRU relays, a third set of WTRU-to-WTRU relays transmitting direct communication request message or link modification request message originated from a same source WTRU for same ProSe services with the WTRU, and a step of selecting the WTRU-to-WTRU relay from the third set of WTRU-to-WTRU relays, based on any of signal strength, local policy, and operator policy per relay service code. On condition that the selected WTRU-to-WTRU relay is from the first set of WTRU-to-WTRU relays, the method may comprise a step of transmitting to the selected WTRU-to-WTRU relay a direct communication accept message and transmitting to all WTRU-to-WTRU relays of the second set of WTRU-to-WTRU relays, other link modification reject messages. The direct communication request message and the link modification request message may comprise information indicating any of proximity-based services, information on the source WTRU information and information on the WTRU. The direct communication accept message may be transmitted in a unicast manner. The link modification request messages may be transmitted in unicast manner. The other link modification reject messages and the link modification reject messages may be transmitted in unicast manner.

In an embodiment, a wireless transmit/receive unit (WTRU) comprising a processor, a transceiver unit and a storage unit, may be configured to receive from each WTRU-to-WTRU relay of a first set of WTRU-to-WTRU relays, a DCR message including a first communication request from a first source WTRU. The WTRU may be configured to receive from each WTRU-to-WTRU relay of a second set of WTRU-to-WTRU relays, a link modification request message including a second communication request from the first source WTRU. The WTRU may be configured to select a WTRU-to-WTRU relay among the first and second sets of WTRU-to-WTRU relays for communication with the first source WTRU; and configured to transmit a link modification reject message to WTRU-to-WTRU relays of the second set of WTRU-to-WTRU relays not selected for communication with the source WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of a message sequence chart of a proximity-based services (ProSe) discovery integrated into a sidelink establishment procedure;

FIG. 3 is an example of a message sequence chart of an integrated discovery with a link modification procedure between wireless transmit/receive units (WTRUs) and a WTRU-to-WTRU relay;

FIG. 4 is an example of a message sequence chart of an integrated discovery procedures between WTRUs and a WTRU-to-WTRU relay with link modification reject/accept procedures;

FIG. 5 is an example of a message sequence chart of an integrated discovery procedures between and a WTRU-to-WTRU relay and WTRUs with direct communication reject; and

FIG. 6 is a flow chart diagram illustrating an example of a method, implemented in a WTRU to perform integrated discovery according to one embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

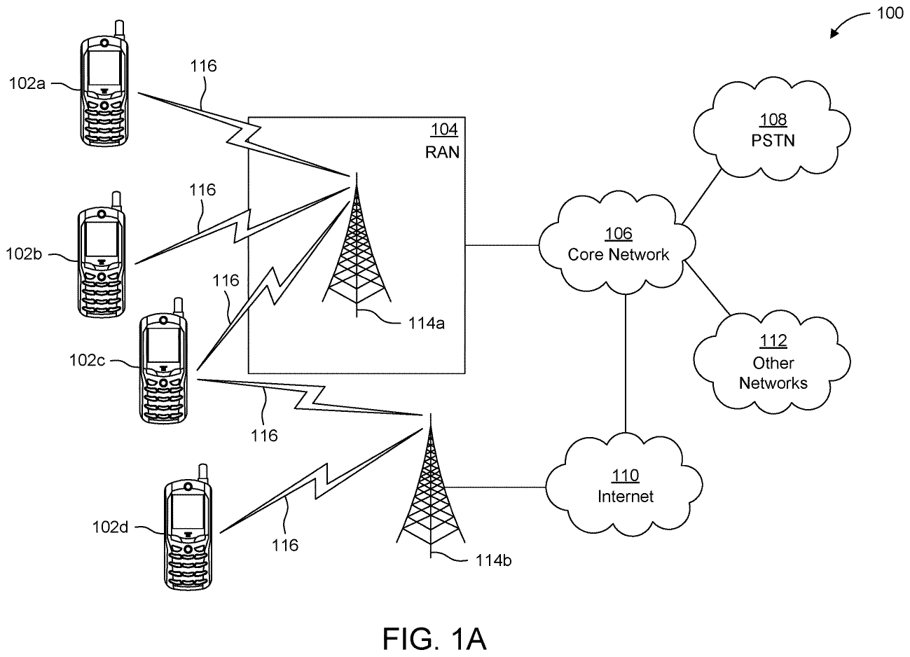

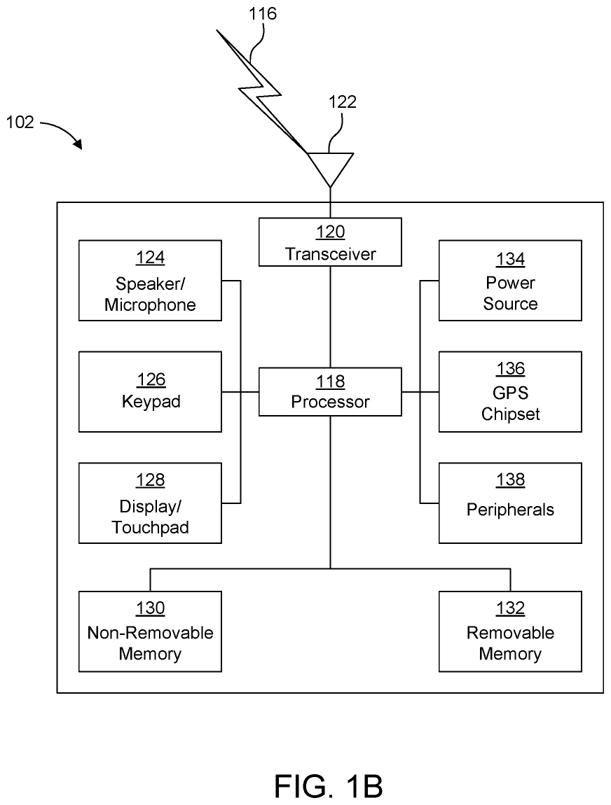

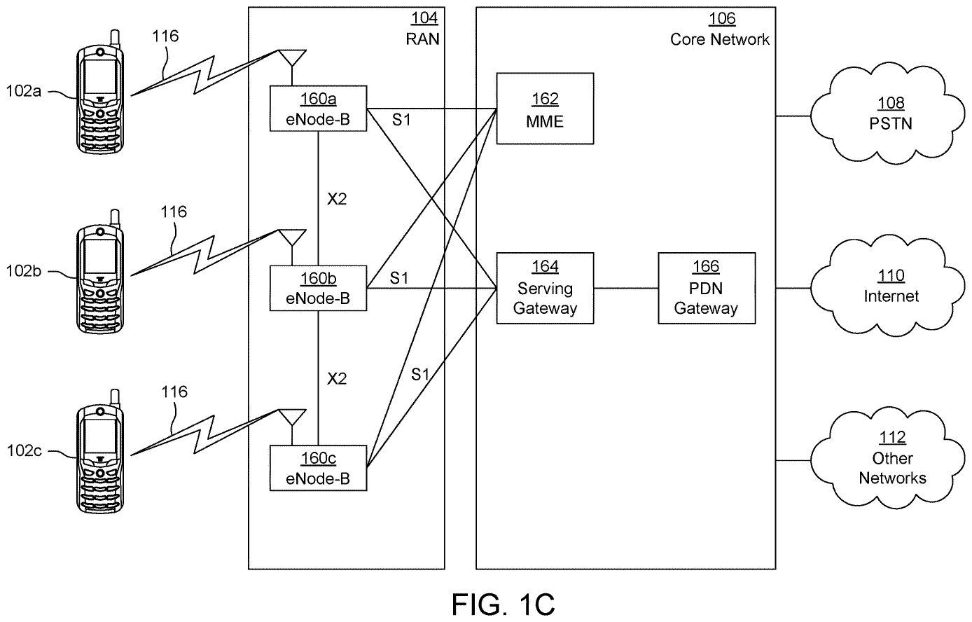

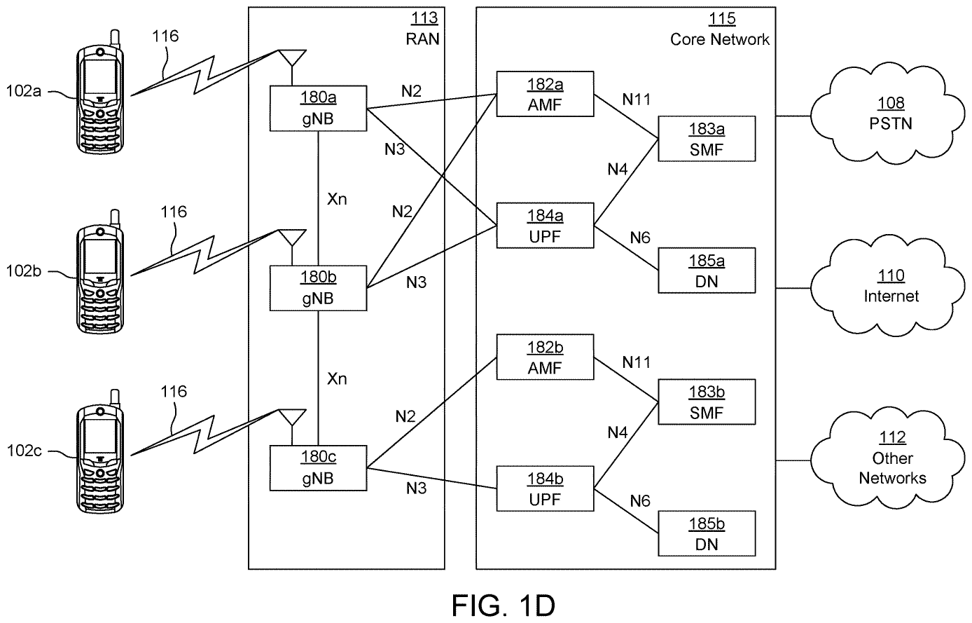

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Proximity based services (ProSe) include services that may be provided by a 5G system based on WTRUs being in proximity to each other. 5G ProSe may have functionalities such as 5G ProSe direct discovery, 5G ProSe direct communication, 5G ProSe WTRU-to-Network Relay, 5G ProSe WTRU-to-WTRU Relay.

In 5G ProSe, after establishing unicast link between two WTRUs, several unicast link management procedures may be defined.

A first unicast link management procedure may be a Layer-2 link release over PC5 reference point. Accordingly, WTRUs may release layer-2 link by exchanging disconnect request messages and disconnect response messages. In releasing layer-2 link, WTRUs may delete all context data associated with the layer-2 link and ProSe layer of each WTRU may inform the access stratum (AS) layer the unicast link has been released with PC5 link identifier to indicate the released unicast link.

A second unicast link management procedure may be a Layer-2 link modification for a unicast link. If WTRUs need to add new PC5 QoS flow(s), modify existing QoS flow(s), or delete existing QoS flow(s) in an existing PC5 unicast link, WTRUs may exchange link modification request messages and link modification response messages with requested action and associated QoS information and optional PC5 QoS rules. QoS information may include the information about PC5 QoS flow(s) and for each PC5 QoS flow, the PC5 QoS flow identifier (PFI), the corresponding PC5 QoS parameters (e.g., PC5 5G NR Standardized QoS identifier (PQI) and conditionally other parameters such as maximum flow bit rate/guaranteed flow bit rate, etc.) and optionally the associated ProSe identifier(s). The ProSe layer of each WTRU may provide information about the unicast link modification to the AS layer. This enables the AS layer to update the context related to the modified unicast link.

A third unicast link management procedure may be a Layer-2 link maintenance over PC5 reference point. WTRUs may exchange keep-alive messages and keep-alive Ack messages to detect if a particular PC5 unicast link is still valid. Keep-alive procedure may be initiated based on for example triggers from the AS layer or internal timers. The WTRUs may minimize the keep-alive signaling, e.g., cancel the procedure if data are successfully received over the PC5 unicast link. The WTRU initiating the keep-alive procedure may determine the follow-up actions based on the result of the signaling, e.g., proceed with implicit layer-2 link release.

5G ProSe may define several features such as 5G ProSe direct discovery, 5G ProSe direct communication, 5G ProSe WTRU-to-Network relay, and 5G ProSe WTRU-to-WTRU relay. 5G ProSe WTRU-to-WTRU relay may enable indirect communication between two 5G ProSe End UEs (e.g., end WTRUs). For 5G ProSe WTRU-to-WTRU Relay, 5G ProSe WTRU-to-WTRU relay discovery and 5G ProSe Communication via WTRU-to-WTRU relay may be defined.

For 5G ProSe WTRU-to-WTRU relay discovery, both Model A and Model B discovery are supported. Model A may use a single discovery protocol message (Announcement). Model B may use two discovery protocol messages (Solicitation and Response).

Discovery integrated into PC5 unicast link establishment procedure may be also supported.

5G ProSe communication via WTRU-to-WTRU Relay may be possible with 5G ProSe Layer-2 WTRU-to-WTRU relay or 5G ProSe Layer-3 WTRU-to-WTRU relay. For Layer-2 WTRU-to-WTRU relay and Layer-3 WTRU-to-WTRU relay, 5G ProSe communication setup with discovery procedures may be defined. Discovery integrated into PC5 unicast link establishment procedure may be defined.

With Layer-2 WTRU-to-WTRU relay, an end-to-end PC5 link may be established between end UEs (e.g., end WTRUs), via the WTRU-to-WTRU relay. PC5 signaling messages may then be exchanged between end UEs (e.g., end WTRUs).

With Layer-3 WTRU-to-WTRU relay, each end UE (e.g., end WTRU) may establish a PC5 link with the WTRU-to-WTRU relay and the WTRU-to-WTRU relay may forward messages towards end UEs (e.g., end WTRUs). PC5 signaling messages may be exchanged between end UEs and the WTRU-to-WTRU relay.

Discovery integrated into PC5 unicast link establishment (so called integrated discovery) may combine discovery procedure into unicast connection setup via WTRU-to-WTRU relay by omitting procedure for 5G ProSe WTRU-to-WTRU relay discovery. One advantage of such procedure may be that the remote WTRU and the WTRU relay may not need to perform a standalone 5G ProSe WTRU-to-WTRU relay discovery.

For discovery integrated into PC5 link establishment, when a WTRU allows a WTRU-to-WTRU relay to be involved in a direct communication request (DCR) message to the other WTRU, the WTRU may indicate it by including a relay_indication in the broadcasted DCR message. A direct communication may be interchangeably referred to as a relayed communication.

When a WTRU-to-WTRU relay receives a DCR message including a relay_indication, the WTRU-to-WTRU relay may participate in the procedure and broadcast a DCR message in its proximity without relay_indication.

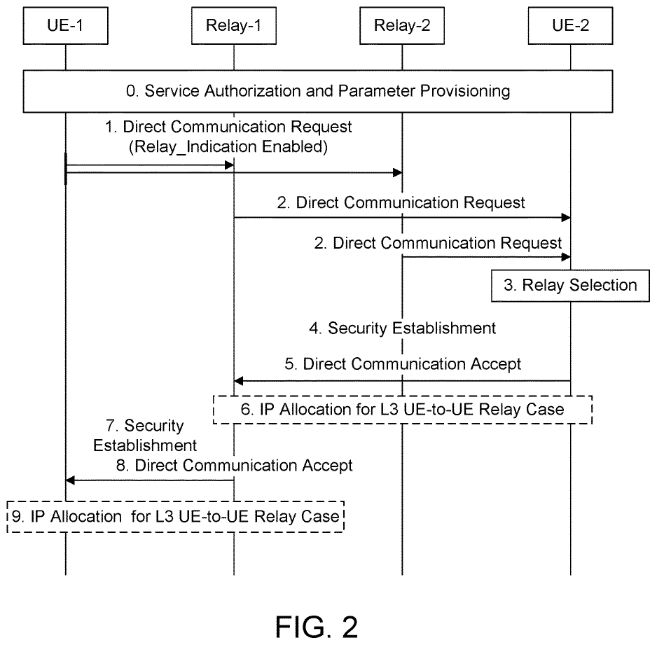

FIG. 2 is an example of a message sequence chart of a 5G ProSe discovery integrated into a sidelink (e.g., PC5 unicast link) establishment procedure.

In direct communication request from the source WTRU (UE-1), without target WTRU's (UE-2) user information, only requested ProSe services information may be included, which is called as service oriented PC5 link setup. In this case, when there is a target WTRU (UE-2) which is interested in the ProSe services requested by the source WTRU (UE-1), the target WTRU (UE-2) may respond to the direct communication request directly to the source WTRU (UE-1) or via WTRU-to-WTRU relay (Relay-1 or Relay-2).

If direct communication request from the source WTRU (UE-1) includes target WTRU's (UE-2) user information, which is called as user oriented PC5 link setup, only the requested target WTRU (UE-2) may respond to the direct communication request directly to the source WTRU (UE-1) or via WTRU-to-WTRU relay (Relay-1 or Relay-2).

At step 1, multiple WTRU-to-WTRU relays (Relay-1 and Relay-2) may receive from the source WTRU (UE-1) a DCR messages. The DCR message broadcasted by the source WTRU (UE-1) may include a relay_indication enabled command.

At step 2 and step 3, when a target WTRU (UE-2) receives the DCR message from one or multiple WTRU-to-WTRU relays (Relay-1 and Relay-2), the target WTRU (UE-2) may select a WTRU-to-WTRU relay which the target WTRU (UE-2) will respond to.

At step 5, the target WTRU (UE-2) may transmit DCA message to the selected WTRU-to-WTRU relay (Relay-1).

At step 8, the selected WTRU-to-WTRU relay (Relay-1) may transmit DCA message to the source WTRU (UE-1).

At step 4, a security establishment procedure between the target WTRU (UE-2) and the selected WTRU-to-WTRU relay (Relay-1) may occur. At step 7, a security establishment procedure between the source WTRU (UE-1) and the selected WTRU-to-WTRU relay (Relay-1) may occur.

At step 6, an IP address assignment procedure between the target WTRU (UE-2) and the selected WTRU-to-WTRU relay (Relay-1) may occur. At step 9, an IP address assignment procedure between the source WTRU (UE-1) and the selected WTRU-to-WTRU relay (Relay-1) may occur.

In addition, in the case of one source WTRU communicates with multiple target WTRUs, the sidelink (e.g., PC5 link) between the source WTRU and a WTRU-to-WTRU relay can be shared for multiple target WTRUs per relay service code (RSC) while the sidelinks (e.g., PC5 links) may be established individually between WTRU-to-WTRU relay and target WTRUs per RSC. For the shared sidelink (e.g., PC5 link), the Layer-2 link modification procedure may be used. The same principle of shared sidelink (e.g., PC5 link) may apply for a target WTRU communicating with multiple source WTRUs.

In the description below, examples of sidelink (e.g., PC5 link) establishment procedure between two WTRUs (e.g., two end UEs) via a WTRU-to-WTRU relay, when integrated discovery is used, are described. More particularly, sidelink (e.g., PC5 link) sharing between a WTRU (e.g., an end UE) and a WTRU-to-WTRU relay, via the usage of sidelink (e.g., PC5 link) modification procedure, is detailed.

In an embodiment, a method, to perform integrated discovery when there is an existing sidelink (e.g., PC5) connection between a source WTRU and a WTRU-to-WTRU relay and/or between a WTRU-to-WTRU and target WTRU, may be characterized with the following functionalities: resolution of conflicted signaling transaction between direct communication request/accept messages and link modification request/response messages, and resolution of conflicted end-to-end QoS negotiation between direct communication request/accept messages and link modification request/response messages.

DCR messages and DCA messages may be used to setup a new sidelink (e.g., PC5) connection and link modification request and response messages may be used to modify existing sidelink (e.g., PC5) connection for sidelink (e.g., PC5) sharing purpose. DCR message may be sent in broadcast manner. DCA message may be transmitted in unicast manner. Link modification request and response messages may be transmitted in unicast manner.

If a source WTRU sends a DCR message to a target WTRU, the source WTRU may expect to receive a DCA from the target WTRU or from WTRU-to-WTRU relay. If a source WTRU sends a link modification request message to the target WTRU, the source WTRU may expect a link modification response from the target WTRU. If the DCR message or the link modification request message is not responded until some timer expires, the source WTRU may re-transmit the DCR message or the link modification request message to the target WTRU. However, when there is an existing link between the source WTRU and WTRU-to-WTRU relay which can be shared for communication with other target WTRUs, a source WTRU or a WTRU-to-WTRU relay sending a DCR message may not receive a DCA message in response but rather a link modification request message because of the link sharing.

In an embodiment, if a source WTRU sends a DCR message to a target WTRU in broadcast manner, the source WTRU may consider the request message is responded when it receives a DCA message from the target WTRU or a link modification request message with proper parameters (e.g., the same ProSe and the related QoS parameters as requested in the direct communication request message and/or target user info of the target WTRU, source user info), from the target WTRU.

Additionally in an embodiment, a message including transaction number may be used to check if a message is responded or not. For example, when a DCR message is transmitted with a value of transaction number, if a DCA message is received with the same value of transaction number, it may be considered received. In case of a link modification request message is received by the source WTRU with the same value of the transaction number as the one in DCR message, the source WTRU may consider the DCR message is responded.

Alternatively, in an embodiment, after a source WTRU sends a DCR message for a target WTRU in broadcast manner, in case of the source WTRU receives a link modification request message from the target WTRU (as a response to the DCR message), the source WTRU may consider the DCR is obsolete and drop any procedure relating to the direct communication request message.

For end-to-end QoS management, if a source WTRU requests a connection with a target WTRU via a WTRU-to-WTRU relay, it may include information of requested ProSe and end to end QoS requirement of the ProSe. Based on the requested end to end QoS requirements, the WTRU-to-WTRU relay may set (e.g., per hop) QoS requirement for the sidelink (e.g., PC5 link) between the source WTRU and the WTRU-to-WTRU relay and for the sidelink (e.g., PC5 link) between the WTRU-to-WTRU relay and the target WTRU.

In case of a source WTRU request an end-to-end QoS requirements, the WTRU-to-WTRU relay may respond to the source WTRU with a (e.g., per hop) QoS requirement for the link between the source WTRU and the WTRU-to-WTRU relay after it negotiates a (e.g., per hop) QoS requirement for the other link between a target WTRU and the WTRU-to-WTRU relay.

In case of a WTRU-to-WTRU relay sends at least (e.g., per hop) one QoS parameter for the link between a target WTRU and the WTRU-to-WTRU relay for end to end connection between a source WTRU and the target WTRU, if the target WTRU responses the same values for (e.g., per hop) the at least one QoS parameter for the link between the target WTRU and the WTRU-to-WTRU relay, the WTRU-to-WTRU relay may consider that the end to end connection is accepted.

In case of a WTRU-to-WTRU relay sends a (e.g., per hop) QoS parameter for link between a target WTRU and the WTRU-to-WTRU relay for end to end connection between a source WTRU and the target WTRU, if the target WTRU responses with different values for (e.g. per hop) QoS parameter from the ones transmitted by the WTRU-to-WTRU relay for the link between the target WTRU and the WTRU-to-WTRU relay, the WTRU-to-WTRU relay may check whether it is acceptable or not. If it is not acceptable, WTRU-to-WTRU relay may consider that the end-to-end connection is rejected.

If the QoS parameter for the link between a target WTRU and a WTRU-to-WTRU relay is agreed, based on the values and end to end QoS requirement, the WTRU-to-WTRU relay may calculate the QoS parameter for the link between a source WTRU and the WTRU-to-WTRU relay.

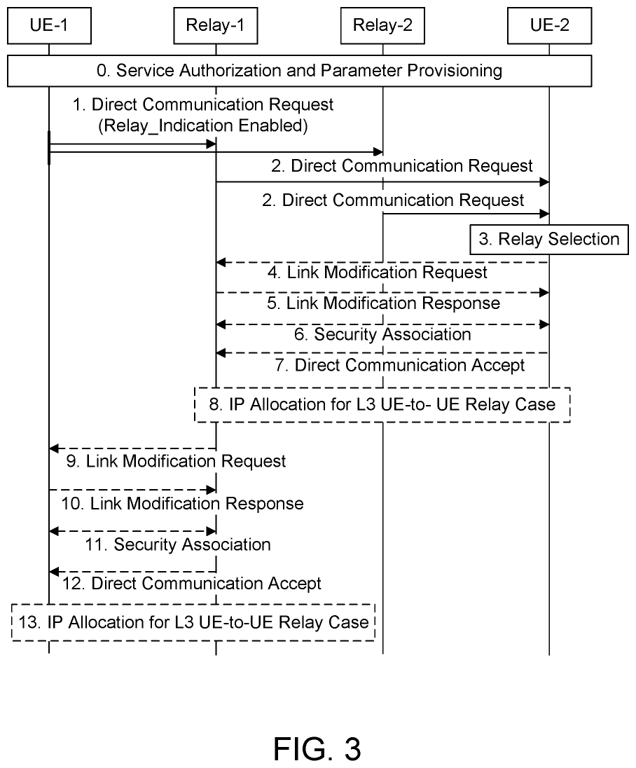

FIG. 3 is an example of a message sequence chart of an integrated discovery with a link modification procedure between a WTRU-to-WTRU relay and WTRUs (e.g., end UEs)

At step 0, WTRUs (UE-1 and UE-2) may be authorized and provisioned with parameters to use the service provided by the WTRU-to-WTRU relays (Relay-1 and Relay-2). In addition, the WTRU-to-WTRU relays (Relay-1 and Relay-2) may be authorized and provisioned with parameters to provide service of relaying traffic among the WTRUs (UE-1 and UE-2).

At step 1, the source WTRU (UE-1) may broadcast a DCR message for initiating a unicast communication with the target WTRU (UE-2). The DCR message may include a relay_indication, source WTRU (UE-1) user info, target WTRU (UE-2) user info, application ID, as well as WTRU-to-WTRU relay service code if there is any. The source WTRU (UE-1) may include requested ProSe services and QoS information relating to the ProSe services.

The source WTRU (UE-1) may send a DCR message without indicating any target WTRU user info when the source WTRU (UE-1) requests a connection setup with any target WTRU supporting the requested ProSe services.

The source WTRU (UE-1) may include a value of message transaction number for the DCR message.

At step 2, the WTRU-to-WTRU relays (Relay-1 and Relay-2) may receive the DCR message including relay_indication from the source WTRU (UE-1). The WTRU-to-WTRU relays (Relay-1 and Relay-2) may decide to participate in the procedure and broadcast another DCR message (e.g., in its proximity) without relay_indication.

Each DCR message from each of the WTRU-to-WTRU relays may include the source WTRU user info (UE-1 user info), target WTRU user info (UE-2 user info) and the WTRU-to-WTRU relay information. The DCR message from any of the WTRU-to-WTRU relays (Relay-1 or Relay-2) may include requested ProSe services as received in step 1 and derived Qos information relating to the ProSe services for the link between WTRU-to-WTRU relays and the target WTRU (UE-2).

When the DCR from the source WTRU (UE-1) received by WTRU-to-WTRU relays (Relay-1 and Relay-2) does not include target WTRU (UE-2) user information, DCR from each WTRU-to-WTRU relays (Relay-1 and Relay-2) does not include target WTRU (UE-2) user information.

WTRU-to-WTRU relays (Relay-1 and Relay-2) may include another value of message transaction number for their DCR message.

At step 3, in case of the target WTRU (UE-2) receiving a DCR from one or multiple WTRU-to-WTRU relays (Relay-1 and Relay-2), the target WTRU (UE-2) may select a WTRU-to-WTRU relay which the target WTRU (UE-2) will respond to. The target WTRU (UE-2) may select a WTRU-to-WTRU relay according to the signal strength from the WTRU-to-WTRU relays, local policy, operator policy per relay service code if any.

In case of the received DRC by the target WTRU (UE-2) does not include target WTRU (UE-2) user information, the target WTRU (UE-2) may decide to respond to the requested DCR if it supports the requested ProSe services.

In case of an existing sidelink (e.g., PC5) connection between the target WTRU (UE-2) and the selected WTRU-to-WTRU relay, step 4 and step 5 may be executed, and step 6 to 8 may be omitted.

In case of the target WTRU (UE-2) needs to setup a new sidelink (e.g., PC5) connection with the selected WTRU-to-WTRU relay, step 4 and step 5 may be omitted and step 6 to 8 may be executed.

At step 4, the target WTRU (UE-2) may respond to the DCR message from the selected WTRU-to-WTRU relay (Relay-1) by transmitting a link modification request messages to the WTRU-to-WTRU relay (Relay-1). The link modification request message may include the source WTRU (UE-1) user information, target WTRU (UE-2) user information and WTRU-to-WTRU relay (Relay-1) information. The link modification request message may include requested ProSe services and QoS information relating to the ProSe services for the link between the selected WTRU-to-WTRU relay (Relay-1) and target UE as received in step 2.

The link modification request message may include the same value of message transaction number as received in step 2 from the selected WTRU-to-WTRU relay (Relay-1).

Alternatively, the target WTRU (UE-2) may comprise requested ProSe services as received in step 2 and QoS information relating to the ProSe services for the link between WTRU-to-WTRU relay (Relay-1) and target WTRUs which is modified based on target WTRU's discretion from the value received in step 2.

At step 5, in case of the WTRU-to-WTRU relay (Relay-1) receives a link modification request message including user information of source WTRU (UE-1) and user information of target WTRU (UE-2) as included in the DCR message transmitted in step 2, the WTRU-to-WTRU relay (Relay-1) may consider DCR message is responded. Alternatively, in case of the link modification request message includes the same value of message transaction number as the one in the DCR transmitted in step 2, the WTRU-to-WTRU relay (Relay-1) may consider the DCR message transmitted in step 2 is responded by link modification request from the target WTRU (UE-2).

At step 6, if necessary, security establishment happens between the target WTRU (UE-2) and the selected (e.g., 5G ProSe) WTRU-to-WTRU relay (Relay-1).

At step 7 the target WTRU (UE-2) may reply DCA message to WTRU-to-WTRU relay (Relay-1). DCA message may include the source WTRU (UE-1) user information, target WTRU (UE-2) user information and WTRU-to-WTRU relay (Relay-1) information relay-1. The DCA message may include requested ProSe services and QoS information relating to the ProSe services for the link between relay and target UE as received in step 2.

The DCA message may include the same value of message transaction number as received in step 2 from the selected relay.

At step 8, for IP traffic, IPv6 prefix or IPv4 address is allocated for the target (e.g., 5G ProSe Layer-3) WTRU (UE-2).

In case of the DCR message transmitted in step 2 is successfully responded in step 4 to 5 or in step 6 to 8, the WTRU-to-WTRU relay (Relay-1) may respond the DCR message transmitted from source WTRU (UE-2) in step 1.

In case of there is an existing sidelink (e.g., PC5) connection between the source WTRU (UE-1) and the WTRU-to-WTRU relay (Relay-1), step 9 and step 10 are executed, and step 11 to 13 are omitted.

In case of the WTRU-to-WTRU relay (Relay-1) establishes a new sidelink (e.g., PC5) connection with the source WTRU (UE-1), step 9 and step 10 are omitted, and step 11 to 13 may be executed.

At step 9, the WTRU-to-WTRU relay (Relay-1) may respond to the DCR message from the source WTRU (UE-1) by transmitting a link modification request message to the source WTRU (UE-1). The link modification request may be transmitted over the existing sidelink (e.g., PC5) connection between the source WTRU (UE-1) and the WTRU-to-WTRU relay (Relay-1).

In case of transmitting the link modification request message as a response to the DCR message from source WTRU (UE-1), the link modification request message may include user information of the source WTRU (UE-1), user information of the target WTRU (UE-2), and user information of the WTRU-to-WTRU relay (Relay-1).

The link modification request message may include requested ProSe services and QoS information relating to the ProSe services for the link between WTRU-to-WTRU relay (Relay-1) and source WTRU (UE-1) which is derived based on the end-to-end QoS information received in step 1.

The link modification request message may include the same value of message transaction number as received in step 1 from source WTRU (UE-1).

At step 10, in case of the source WTRU (UE-1) receives a link modification request, if it includes user information of the source WTRU (UE-1) and user information of the target WTRU (UE-2) as included in the DCR message transmitted in step 1 or if the link modification request message includes the same value of message transaction number as the one in the DCR transmitted in step 1, the source WTRU (UE-1) may consider the DCR message is responded with the link modification request message and the source WTRU (UE-1) may respond with link modification response message.

At step 11, if necessary, a security establishment may occur between the source WTRU (UE-1) and the WTRU-to-WTRU relay (Relay-1).

At step 12, the WTRU-to-WTRU relay (Relay-1) may respond to the source WTRU (UE-1) by transmitting a DCA message to the source WTRU (UE-1).

DCA message may include user information of the source WTRU (UE-1), user information of the target WTRU (UE-2), and user information of the WTRU-to-WTRU relay (Relay-1). The DCA message may include requested ProSe services and QoS information relating to the ProSe services for the link between the WTRU-to-WTRU relay (Relay-1) and the source WTRU (UE-1) which may be derived based on the end-to-end QoS information received in step 1.

The DCA message may include the same value of message transaction number as received in step 1 from the source WTRU (UE-1).

At step 13, for IP traffic, IPv6 prefix or IPv4 address may be allocated for the source (e.g., 5G ProSe Layer-3) WTRU (UE-1).

In another embodiment, a method, to perform integrated discovery when there is an existing sidelink (e.g., PC5) connection between a source WTRU and a WTRU-to-WTRU relay and/or between a WTRU-to-WTRU and target WTRU, may be characterized with the following functionalities: (1) After receiving a DCR message from a source WTRU, a WTRU-to-WTRU relay UE may verify if a sidelink (e.g., PC5) connection with a target WTRU already exists based on the target WTRU information. If there is no existing sidelink (e.g., PC5) connection between the WTRU-to-WTRU relay and the target WTRU, WTRU-to-WTRU relay may send a DCR message including requested ProSe services and target WTRU information. If WTRU-to-WTRU relay finds an available sidelink (e.g., PC5) connection with the target WTRU, the WTRU-to-WTRU relay may send a link modification request to provide the connection between the source WTRU and the target WTRU for the ProSe services as requested in the DCR message from the source WTRU with sidelink (e.g., PC5 link) sharing between the WTRU-to-WTRU relay and the target WTRU; (2) The target WTRU may compare received DCR messages and link modification request messages from WTRU-to-WTRU relays to select a WTRU-to-WTRU relay for connection with a source WTRU for the requested ProSe services. (3) If a WTRU-to-WTRU relay which sends a link modification request message to the target WTRU is not selected for connection between the target WTRU and the source WTRU, target WTRU may send a link modification reject message to inform that the WTRU-to-WTRU relay is not selected. (4) After selecting a WTRU-to-WTRU relay for the connection between the source WTRU and the target WTRU, the target WTRU may respond to the selected WTRU-to-WTRU relay using a response message corresponding to the request message from WTRU-to-WTRU relay. For example, the target WTRU may send a link modification accept (LMA) message as a response to link modification request and may send a DCA message as a response to a DCR message.

In an embodiment, when the target WTRU receives DCR and link modification request messages from WTRU-to-WTRU relays, the target WTRU may check requested ProSe services, source WTRU information and target WTRU information in the received DCR and link modification request messages, in order to determine whether those messages are originated from the same source WTRU for the same ProSe services with target WTRU. Based on said determination, the target WTRU may select a WTRU-to-WTRU relay which seems to be most proper for the connection with the source WTRU.

Alternatively, the source WTRU may include a “request ID” in the DCR message and the WTRU-to-WTRU may include this request ID in the DCR and link modification request message transmitted toward the target WTRU. Target WTRU may check DCR and link modification request with same request ID to evaluate whether they are originated from same request from the same source WTRU.

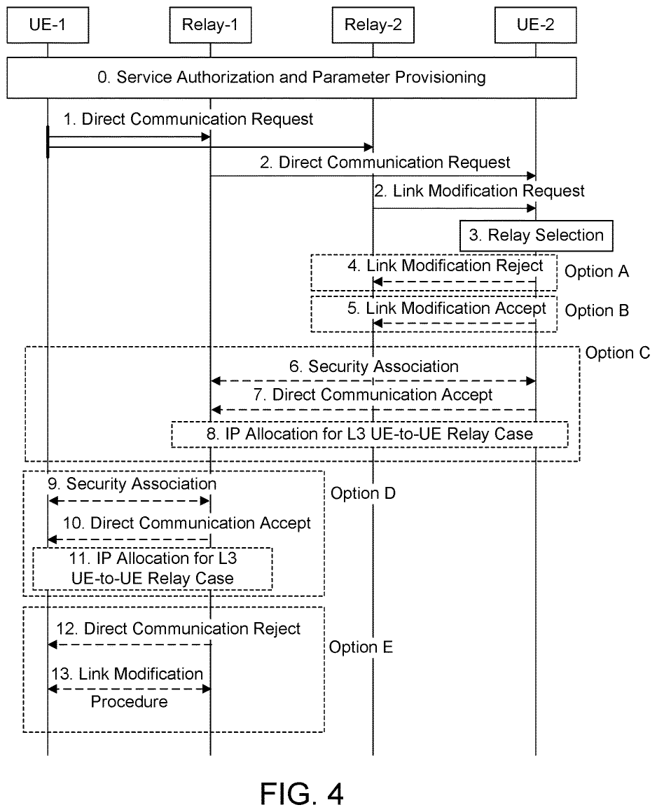

FIG. 4 is an example of a message sequence chart of an integrated discovery link procedure between WTRUs (e.g., end UEs) and a WTRU-to-WTRU relay with link modification reject/accept procedures.

At step 0, source WTRU (e.g., UE-1) and target WTRU (e.g., UE-2) may be authorized and provisioned with parameters to use the service provided by the WTRU-to-WTRU relays (e.g., Relay-1 and Relay-2). WTRU-to-WTRU relays may be authorized and provisioned with parameters to provide service of relaying traffic among source WTRU and target WTRU.

At step 1, the source WTRU (e.g., UE-1) may request establishment of a unicast communication with the target WTRU (e.g., UE-2) and thus may broadcast a DCR message.

The source WTRU (e.g., UE-1) may include a value of request ID for the DCR message.

DCR may include a sidelink (e.g., PC5 link) sharing policy (e.g., link sharing PREFERRED, REQUIRED, NOT NEEDED). The link sharing policy may apply and may be provisioned in the WTRUs/WTRU-to-WTRU relay on a per ProSe or RSC basis. For example, a particular ProSe service or RSC may require dedicated connection usage across the WTRU-to-WTRU relay (e.g., not allowing link sharing) to enforce security/traffic isolation.

At step 2, when receiving DCR from the source WTRU (e.g., UE-1), the WTRU-to-WTRU relays (e.g., Relay-1 and Relay-2) may decide to participate in the procedure. As default operation, the WTRU-to-WTRU relays may broadcast a Direct Communication Request message in its proximity.

If there is an existing sidelink (e.g., PC5) connection between a WTRU-to-WTRU relay (e.g., Relay-2) and the target WTRU (e.g., UE-2), instead of broadcasting a DCR message, the WTRU-to-WTRU relay (e.g., Relay-2) may send a link modification request message over the existing sidelink (e.g., PC5) connection. If an existing sidelink (e.g., PC5) exists with the target WTRU (e.g., UE-2), the WTRU-to-WTRU relay (e.g., Relay-2) may decide to request a new link with DCR message or reuse an existing link with link modification request according to the link sharing policy, as described above.

The DCR message may include the source WTRU (e.g., UE-1) user information, the target WTRU (e.g., UE-2) user information and the WTRU-to-WTRU relay (e.g., Relay-2) information in the message. The message may include requested ProSe services as received in step 1.

If a link modification request message is transmitted in step 2, the link modification request message may include the source WTRU (e.g., UE-1) user information. It may include the target WTRU (e.g., UE-2) user information and the WTRU-to-WTRU relay (e.g., Relay-2) information in the message and requested ProSe services as received in step 1.

When the received DCR message does not include target WTRU user information, the WTRU-to-WTRU relay (e.g., Relay-2) may not include the target WTRU user information in the DCR in step 2.

The WTRU-to-WTRU relay (e.g., Relay-2) may include a value of request ID in the DCR message and in the link modification request message as received on the DCR message from the source WTRU.

At step 3, when the target WTRU (e.g., UE-2) receives DCR messages and link modification request messages from one or multiple WTRU-to-WTRU relays for connection setup with the source WTRU (e.g., UE-1) via WTRU-to-WTRU relay, the target WTRU (e.g., UE-2) may verify the received DCR messages and link modification request messages are originated from same source WTRU for same requested ProSe services. It may be verified by comparing included parameters such as e.g., source WTRU user information, application ID, and requested ProSe services. Additionally, or alternatively, it may be verified by comparing included request ID.

Among the WTRU-to-WTRU relays which transmitted DCR or link modification request for same source WTRU (e.g., UE-1), the target WTRU (e.g., UE-2) may select a WTRU-to-WTRU relay which the target WTRU will respond to. The target WTRU may select WTRU-to-WTRU relay according to the signal strength, local policy, operator policy per RSC if any. For example, the target WTRU (e.g., UE-2) may prioritize the WTRU-to-WTRU relay by privileging relay with sidelink (e.g., PC5 link) sharing opportunity (e.g., Relay-2), to avoid the overhead of an additional sidelink (e.g., PC5 link) setup and maintenance (e.g., with Relay-1), and according to sidelink (e.g., PC5 link) sharing policy.

When the received DCR message does not include target WTRU user information, target WTRU (e.g., UE-2) may decide to respond to the DCR message when it supports the requested ProSe services.

At step 4., in an option (Option A), if a WTRU-to-WTRU relay has transmitted a link modification request message for connection setup with the source WTRU but the WTRU-to-WTRU relay is not selected for the connection with source WTRU, the target WTRU may send link modification reject to the WTRU-to-WTRU relay which may indicate that the WTRU-to-WTRU relay is not selected for connection between the source WTRU (e.g., UE1) and the target WTRU (e.g., UE2). When the link modification reject is received, the WTRU-to-WTRU relay may consider that the request in step 2 is rejected, and it does not need to be requested or retransmitted anymore. The link modification reject message may include an indication/cause code indicating that the WTRU-to-WTRU relay is not selected by the target WTRU for this particular connection request. The link modification reject message may alternatively indicate that link sharing is not allowed based on the target WTRU link sharing policy. In this latter case, the WTRU-to-WTRU relay may retransmit a DCR in response to initiate a new link setup instead.

The link modification reject message may include the source WTRU (e.g., UE-1) user information, the target WTRU (e.g., UE-2) user information, the WTRU-to-WTRU relay information, requested ProSe services and may include the same value of request ID as received in step 2 from WTRU-to-WTRU relay (e.g., relay-2).

At step 5, in an option (Option B), if a WTRU-to-WTRU relay has transmitted a link modification request message for connection setup with the source WTRU (e.g., UE-1) and the WTRU-to-WTRU relay is selected for the connection with the source WTRU, the target WTRU (e.g., UE-2) may send a link modification accept to the WTRU-to-WTRU relay. And steps 6, 7, and 8 do not proceed as the WTRU-to-WTRU relay (e.g., Relay-1) is not selected for the connection between the source WTRU and the target WTRU.

The link modification accept message may include the source WTRU (e.g., UE-1) user information, the target WTRU (e.g., UE-2) user information, the WTRU-to-WTRU relay information, requested ProSe services and the request ID.

When the target WTRU selects a WTRU-to-WTRU relay (e.g., Relay-1) which has transmitted a DCR for connection with the source WTRU and there is no existing sidelink (e.g., PC5) connection between the target WTRU and the selected WTRU-to-WTRU relay for the connection with the source WTRU, the target WTRU may perform steps 6, 7, and 8.

At step 6, in an option (Option C), the target WTRU (e.g., UE2) may trigger security establishment between the target WTRU (e.g., UE-2) and the selected (e.g., 5G ProSe) WTRU-to-WTRU relay (e.g., Relay-1), if needed.

At step 7, the target WTRU may reply a DCA message to the selected WTRU-to-WTRU relay (e.g., relay-1).

DCA message may include the source WTRU user information, target WTRU user information and the selected WTRU-to-WTRU relay (e.g., Relay-1) information in the message and requested ProSe services.

The message may include the same value of request ID as received in step 2 from the selected WTRU-to-WTRU relay.

At step 8, for IP traffic, IPv6 prefix or IPv4 address may be allocated for the target (e.g., 5G ProSe layer-3) WTRU.

When the direct communication request transmitted in step 2 is successfully responded, the WTRU-to-WTRU relay may respond the direct communication request message transmitted from the source WTRU in step 1.

Step 9 to step 13 may be performed in case the selected WTRU-to-WTRU relay (e.g., relay-1) receives a response from the target WTRU which accepts the DCR or link modification request for connection with the source WTRU. In case the other WTRU-to-WTRU relay (e.g., relay-2) receives a respond from the target WTRU which accept the request, step 9 to step 13 will be performed between the source WTRU (e.g., UE-1) and the other WTRU-to-WTRU relay (e.g., relay-2).

In an option (Option D), If the other WTRU-to-WTRU relay needs to setup a new sidelink (e.g., PC5) connection with the source WTRU (e.g., UE-1), step 9, step 10, and step 11 may be performed and step 12 and step 13 may be omitted.

In an option (Option E), if there is an existing sidelink (e.g., PC5) connection between the source WTRU (e.g., UE-1) and the WTRU-to-WTRU relay (Relay-1), step 12 and step 13 are performed and step 9, step 10, and step 11 are omitted.

At step 9, according to Option D, security establishment may happen between the source WTRU (e.g., UE-1) and the WTRU-to-WTRU relay (e.g., relay-1), if needed.

At step 10, the WTRU-to-WTRU relay (e.g., Relay-1) may respond with DCA message to the source WTRU (e.g., UE-1).

DCA message may include user information of source WTRU, user information of target WTRU, and user info of the WTRU-to-WTRU relay (e.g., Relay-1). The message may include requested ProSe services.

The message may include the same value of request ID as received in step 1 from the source WTRU.

At step 11, for IP traffic, IPv6 prefix or IPv4 address may be allocated for the source (e.g., 5G ProSe Layer-3) WTRU.

At step 12, in an option (option E), if there is an existing sidelink (e.g., PC5) connection between the WTRU-to-WTRU relay (e.g., Relay-1) and the source WTRU, the WTRU-to-WTRU relay (e.g., Relay-1) may send a direct communication reject message with reject cause (e.g., “use existing link”). The reject cause may indicate that a new sidelink (e.g., PC5) connection between the source WTRU and the WTRU-to-WTRU relay (e.g., Relay-1) is not established for connection with target WTRU and existing sidelink (e.g., PC5) connection between the source WTRU and WTRU-to-WTRU relay (e.g., Relay-1) may (e.g., already) exist and should be reused. Direct communication reject message may include an indication/cause code indicating that an existing link is available for link sharing.

The message may include the same value of request ID as received in step 1 from the source WTRU.

At step 13, after receiving a direct communication reject message with “use existing link” cause, the source WTRU (UE-1) may trigger link modification procedure between the source WTRU and the WTRU-to-WTRU relay (e.g., Relay-1) to update the existing sidelink (e.g., PC5) connection to add ProSe services for connection with the target WTRU (e.g., UE-2).

Alternatively, link modification procedure may be triggered by the WTRU-to-WTRU relay (e.g., relay-1) when receiving a DCA (or when receiving a LMA in case relay-2 is selected). In that case, step 12 may be omitted.

In another embodiment, a method, to perform integrated discovery when there is an existing sidelink (e.g., PC5) connection between a source WTRU and a WTRU-to-WTRU relay and/or between a WTRU-to-WTRU and a target WTRU, may be characterized with the following functionalities: (1) After receiving a DCR message from a source WTRU, a WTRU-to-WTRU relay may send DCR message including requested ProSe services and potentially target WTRU information. (2) The target WTRU may compare received messages from a WTRU-to-WTRU relays and select a WTRU-to-WTRU relay for connection with the source WTRU for the requested ProSe services. (3) When a relay WTRU is selected and there is an existing connection between a WTRU-to-WTRU relay and a target WTRU, the target WTRU may decide to reuse existing sidelink (e.g., PC5) for the connection with the source WTRU. In this case, the target WTRU may respond with direct communication reject message with reject code saying that there is existing connection. (4) After sending a direct communication reject message, a link modification procedure is performed between the target WTRU and the WTRU-to-WTRU relay to modify existing sidelink (e.g., PC5) for the connection with the source WTRU. (5) When a WTRU-to-WTRU relay responds to the source WTRU based on the response from the target WTRU and the WTRU-to-WTRU relay finds an existing sidelink (e.g., PC5) connection between the source WTRU and the WTRU-to-WTRU relay, the WTRU-to-WTRU relay may respond with a direct communication reject message with reject code saying that there is existing connection. After sending a direct communication reject, a link modification procedure is performed between the source WTRU and the WTRU-to-WTRU relay to modify existing sidelink (e.g., PC5) for the connection with the target WTRU.

In an embodiment, when a target WTRU receives direct communication request message from WTRU-to-WTRU relays, target WTRU may check requested ProSe services, the source WTRU user information and target WTRU user information (if provided) in the received direct communication request message, in order to determine whether those messages are originated from same source WTRU for same ProSe services. Based on determination, target WTRU may select a WTRU-to-WTRU relay which seems to be most proper for the connection with the source WTRU.

Alternatively, or in addition, a request ID may be included in the direct communication request message as same as received direct communication request message from source WTRU. Target WTRU may check direct communication request message with same request ID to evaluate whether they are originated from same request from same source WTRU.

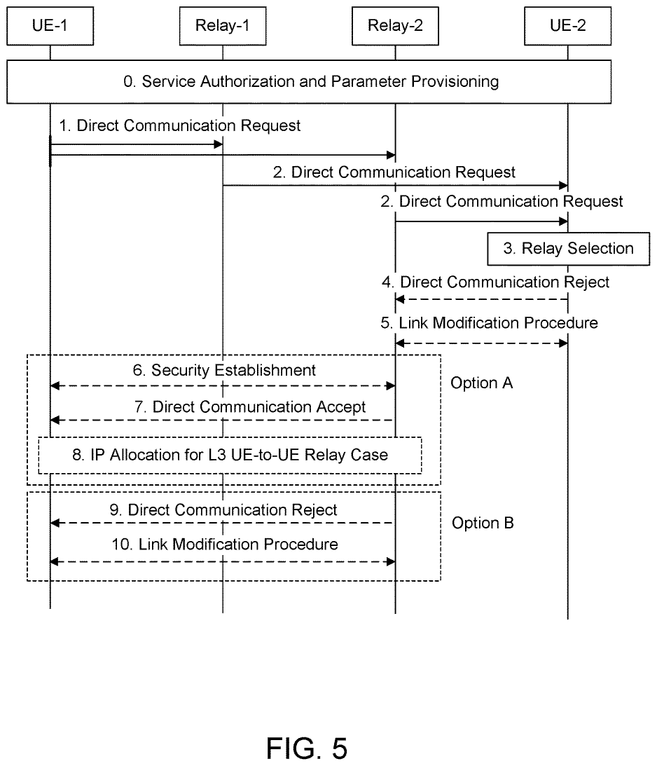

FIG. 5 is an example of a message sequence chart of an integrated discovery procedures between a WTRU-to-WTRU relay and WTRUs with direct communication reject.

At step 0, source WTRU (e.g., UE-1) and target WTRU (e.g., UE-2) may be authorized and provisioned with parameters to use the service provided by the WTRU-to-WTRU relays. The WTRU-to-WTRU relays may be authorized and provisioned with parameters to provide service of relaying traffic among the source WTRU (e.g., UE-1) and the target WTRU (e.g., UE-2). The source WTRU (e.g., UE-1), target WTRU (e.g., UE-2) and WTRU-to-WTRU relay may be provisioned by a ProSe key management function (PKMF) with security parameters (e.g., confidentiality key) associated with RSC.

At step 1, the source WTRU (e.g., UE-1) may request establishment of a unicast communication for specific application ID and/or ProSe services and may broadcast a direct communication request. The direct communication request may include the source WTRU (e.g., UE-1) user information, application ID, and relay service code if there is any and it may include requested ProSe services and target WTRU (UE-2) user information.

The source WTRU (e.g., UE-1) may include a value of Request ID for the direct communication request message. The source WTRU (e.g., UE-1) may protect parameters (e.g., Request ID, requested ProSe services) for confidentiality and from replay (e.g., using a time-based counter) using the security parameters.

At step 2, when receiving a direct communication request message from the source WTRU (e.g., UE-1), WTRU-to-WTRU relays (e.g., Relay-1 and Relay-2) may decide to participate in the procedure. As default operation, WTRU-to-WTRU relays may broadcast a direct communication request message in its proximity.

The direct communication request message may include the source WTRU (e.g., UE-1) user information, the target WTRU (e.g., UE-2) user information (if received from the source WTRU) and WTRU-to-WTRU relay information. The message may include requested ProSe services as received in step 1.

When the received direct communication request message does not include the target WTRU user info, WTRU-to-WTRU relay information does not include target WTRU user information in the direct communication request in step 2.

WTRU-to-WTRU relay may comprise information indicating a value of Request ID for the direct communication request message as received at step 1. The WTRU-to-WTRU relay may protect parameters (e.g., Request ID, requested ProSe services) in the direct communication request message for confidentiality and from replay using the security parameters.

At step 3, when the target WTRU (e.g., UE-2) receives direct communication request message from one or multiple WTRU-to-WTRU relays for connection setup with the source WTRU (e.g., UE-1) via a WTRU-to-WTRU relay, the target WTRU (e.g., UE-2) may verify if the received direct communication request messages are originated from same source WTRU for same requested ProSe services. It may be verified by comparing included parameters such as e.g., source WTRU user information, application ID, and requested ProSe services. Additionally, or alternatively, it may be verified by comparing included request ID.

Among the WTRU-to-WTRU relays which transmitted direct communication request message for same source WTRU, the target WTRU may select a WTRU-to-WTRU relay which the target WTRU (e.g., UE-2) will respond to. The target WTRU (e.g., UE-2) may select a WTRU-to-WTRU relay according to the signal strength, local policy, operator policy per relay service code if any.

At step 4, if there is an existing sidelink (e.g., PC5) connection between the target WTRU (e.g., UE-2) and the selected WTRU-to-WTRU relay (e.g., Relay-2), target WTRU may send direct communication reject with reject cause “use existing link”, e.g. indicating that new sidelink (e.g., PC5) connection between the target WTRU and the selected WTRU-to-WTRU relay may not be established for connection with source WTRU and existing sidelink (e.g., PC5) connection between target WTRU and the selected WTRU-to-WTRU should be reused.

The message may include the same value of request ID as received in step 2. The target WTRU may protect parameters (e.g., Request ID) in the direct communication reject message for confidentiality and from replay using the security parameters.

At step 5, the link modification procedure between the source WTRU and the selected WTRU-to-WTRU relay (e.g., Relay-2) may be performed to update existing sidelink (e.g., PC5) connection to add ProSe services for connection with the source WTRU. Link modification procedure may be triggered by the target WTRU or by the selected WTRU-to-WTRU relay (e.g., Relay-2). WTRU-to-WTRU relay (e.g., Relay-2) may verify the security of the direct communication reject message parameters and verify they are matching the parameters in the direct communication request message. WTRU-to-WTRU relay may proceed with the link modification procedure if the communication reject message verification is successful, otherwise the WTRU-to-WTRU relay may ignore the direct communication reject message.

In option A, if the selected WTRU-to-WTRU relay (e.g., Relay-2) needs to setup a new sidelink (e.g., PC5) connection with the source WTRU (e.g., UE-1), step 6, step 7, and step 8 may be performed and step 9 and step 10 may be omitted.

In option B, if there is an existing sidelink (e.g., PC5) connection between the source WTRU and the selected WTRU-to-WTRU relay (e.g., Relay-2), step 9 and step 10 may be performed and step 6, step 7, and step 8 may be omitted.

At step 6, a security establishment happens between the source WTRU (e.g., UE-1) and the selected WTRU-to-WTRU relay (e.g., Relay-2), if needed.

At step 7, the selected WTRU-to-WTRU relay (e.g., Relay-2) may respond with a direct communication accept message to the source WTRU (e.g., UE-1).

The direct communication accept message may include user information of the source WTRU, user information of the target WTRU, and user information of the selected WTRU-to-WTRU relay (e.g., Relay-2). The message may include requested ProSe services.

The message may include the same value of request ID as received in step 1 from the source WTRU.

At step 8, for IP traffic, IPV6 prefix or IPv4 address may be allocated for the source (e.g., 5G ProSe Layer-3) WTRU.

At step 9, if there is an existing sidelink (e.g., PC5) connection between the selected WTRU-to-WTRU relay (e.g., Relay-2) and the source WTRU, the selected WTRU-to-WTRU relay (e.g., Relay-2) may send a direct communication reject indicating that new sidelink (e.g., PC5) connection between the source WTRU and the selected WTRU-to-WTRU relay (e.g., Relay-2) is not established for connection with target WTRU and existing sidelink (e.g., PC5) connection between the source WTRU and the selected WTRU-to-WTRU relay (e.g., Relay-2) should be reused.

The message may include the same value of request ID as received in step 1 from source WTRU. The WTRU-to-WTRU relay may protect parameters (e.g., Request ID) in the direct communication reject message for confidentiality and from replay using the security parameters.

At step 10, after sending direct communication reject message to the source WTRU, a link modification procedure between the source WTRU and the selected WTRU-to-WTRU relay (e.g., Relay-2) can be performed to update (e.g., existing) sidelink (e.g., PC5) connection to add ProSe services for connection with target WTRU. Link modification procedure may be triggered by source WTRU or the selected WTRU-to-WTRU relay (e.g., Relay-2). The selected WTRU-to-WTRU relay (e.g., Relay-2) may not send the direct communication reject message to the source WTRU and may trigger the link modification procedure. Source WTRU may verify the security of the direct communication reject message parameters and verify they are matching the parameters in the direct communication request message. Source WTRU may proceed with the link modification procedure if the communication reject message verification is successful, otherwise the Source WTRU may ignore the direct communication reject message.

In an embodiment, a method, implemented in a first wireless transmit/receive unit, WTRU, to perform integrated discovery when there is an existing sidelink connection between the first WTRU or a second WTRU and at least one WTRU-to-WTRU relay, may comprise a step of transmitting, to the second WTRU, via the at least one WTRU-to-WTRU relay, a direct communication request, DCR, message comprising proximity-based services, ProSe, parameters. The method may further comprise a step of receiving, from the second WTRU, via one of the at least one WTRU-to-WTRU relay, a link modification request message comprising information related to the ProSe services parameters. The method may further comprise a step of transmitting, to the one of the at least one WTRU-to-WTRU relay, a link modification response message; and A step of receiving, from the one of the at least one WTRU-to-WTRU relay, a direct communication accept (DCA) message.

The DCR message may include any of relay_indication, first WTRU user information, second WTRU user information, an application ID, and relay service code. The first WTRU may comprise ProSe services and QoS information relating to the ProSe services. The method may further comprise a step of determining that the received information are related to the proximity-based service parameters. The DCR message may include a value of message transaction number, and wherein the link modification request message comprises the value of message transaction number. The DCR message may comprise information including Quality of Service, QoS, information related to the proximity-based service, such that the method may comprise a step of receiving QoS requirement from the WTRU-to-WTRU relay for the link between WTRU-to-WTRU relay and the first WTRU. DCR messages may be transmitted in a broadcast manner. The link modification request message may be transmitted in unicast manner. The link modification response message may be transmitted in unicast manner.

In an embodiment, a method, implemented in a WTRU-to-WTRU relay, may comprise a step of receiving, from a first WTRU, a direct communication request, DCR, message comprising information including Quality of Service, QoS, information related to a proximity-based service. The method may further comprise a step of determining first values of QoS parameter for the link between the first WTRU and the WTRU-to-WTRU relay. The method may comprise a step of transmitting, to a second WTRU, the DCR message. The method may comprise a step of receiving, from the second WTRU, second values of QoS parameters for the link between the second WTRU and the WTRU-to-WTRU relay; and a step of determining whether a direct communication between the first and the second WTRU is accepted based on the first values of QoS parameters and the second values of QoS parameters. The method may further comprise a step of transmitting to the first WTRU, the first values of QoS parameter for the link between the first WTRU and the WTRU-to-WTRU relay.

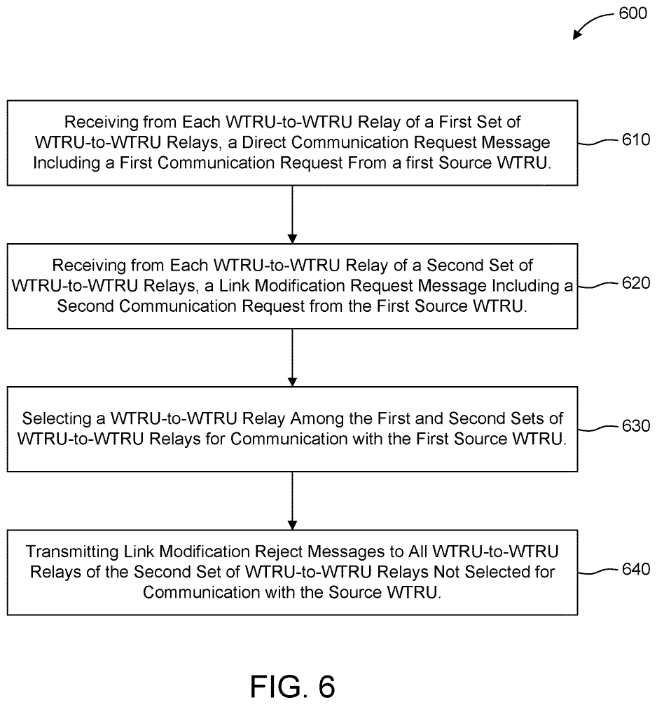

Referring to FIG. 6, a method 600 implemented in a wireless transmit/receive unit, WTRU, to perform integrated discovery may comprise a step of receiving 610 from each WTRU-to-WTRU relay of a first set of WTRU-to-WTRU relays, a direct communication request message including a first communication request from a first source WTRU. The method 600 may comprise a step of receiving 620 from each WTRU-to-WTRU relay of a second set of WTRU-to-WTRU relays, a link modification request message including a second communication request from the first source WTRU. The method 600 may comprise a step of selecting 630 a WTRU-to-WTRU relay among the first and second sets of WTRU-to-WTRU relays for communication with the first source WTRU; and a step of transmitting 640 link modification reject messages to all WTRU-to-WTRU relays of the second set of WTRU-to-WTRU relays not selected for communication with the source WTRU.

On condition that the selected WTRU-to-WTRU relay is from the first set of WTRU-to-WTRU relays and an existing sidelink connection between the WTRU and the selected WTRU-to-WTRU relay is already established, the method 600 may comprise a step of transmitting a direct communication reject message to the selected WTRU-to-WTRU relay. The method 600 may comprise a step of comprising performing a link modification procedure with the selected WTRU-to-WTRU relay for modifying the existing sidelink connection. The step of selecting a WTRU-to-WTRU relay may comprise a step of selecting, among the first and second sets of WTRU-to-WTRU relays, a third set of WTRU-to-WTRU relays transmitting direct communication request message or link modification request message originated from a same source WTRU for same ProSe services with the WTRU, and a step of selecting the WTRU-to-WTRU relay from the third set of WTRU-to-WTRU relays, based on any of signal strength, local policy, and operator policy per relay service code. On condition that the selected WTRU-to-WTRU relay is from the first set of WTRU-to-WTRU relays, the method 600 may comprise a step of transmitting to the selected WTRU-to-WTRU relay a direct communication accept message and transmitting to all WTRU-to-WTRU relays of the second set of WTRU-to-WTRU relays, other link modification reject messages. The direct communication request message and the link modification request message may comprise information indicating any of proximity-based services, information on the source WTRU information and information on the WTRU. The direct communication accept message may be transmitted in a unicast manner. The link modification request messages may be sent in unicast manner. The link modification reject messages and the other link modification reject messages may be sent in unicast manner.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least.” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented in a wireless transmit/receive unit (WTRU) comprising:
receiving from each WTRU-to-WTRU relay of a first set of WTRU-to-WTRU relays, a direct communication request message including a first communication request from a first source WTRU;
receiving from each WTRU-to-WTRU relay of a second set of WTRU-to-WTRU relays, a link modification request message including a second communication request from the first source WTRU;
selecting a WTRU-to-WTRU relay among the first and second sets of WTRU-to-WTRU relays for communication with the first source WTRU; and
transmitting a link modification reject message to all WTRU-to-WTRU relays of the second set of WTRU-to-WTRU relays not selected for communication with the source WTRU, wherein the link modification reject message includes a first indication on that the WTRU-to-WTRU relays of the second set of WTRU-to-WTRU relays are not selected by the WTRU.

2. The method of claim 1, wherein, on condition that the selected WTRU-to-WTRU relay is from the first set of WTRU-to-WTRU relays and an existing sidelink connection between the WTRU and the selected WTRU-to-WTRU relay is already established, transmitting a direct communication reject message to the selected WTRU-to-WTRU relay, wherein the direct communication reject message includes a second indication on that there is existing connection.

3. The method of claim 2, comprising performing a link modification procedure with the selected WTRU-to-WTRU relay for modifying the existing sidelink connection.

4. The method of claim 1, wherein selecting a WTRU-to-WTRU relay comprises:
selecting, among the first and second sets of WTRU-to-WTRU relays, a third set of WTRU-to-WTRU relays transmitting direct communication request message or link modification request message originated from a same source WTRU for same ProSe services with the WTRU; and
selecting the WTRU-to-WTRU relay, from the third set of WTRU-to-WTRU relays, based on any of signal strength, local policy, and operator policy per relay service code.

5. The method of claim 1, wherein the link modification reject message is a first link modification reject message, and wherein, on condition that the selected WTRU-to-WTRU relay is from the first set of WTRU-to-WTRU relays, transmitting to the selected WTRU-to-WTRU relay a direct communication accept message and transmitting to all WTRU-to-WTRU relays of the second set of WTRU-to-WTRU relays, a second link modification reject message.

6. The method of claim 1, wherein the direct communication request message and the link modification request message comprise information indicating any of proximity-based services, information on the source WTRU information and information on the WTRU.

7. The method of claim 5, wherein the direct communication accept message is transmitted in a unicast manner.

8. The method of claim 1, wherein the link modification request message is transmitted in unicast manner.

9. The method of claim 5, wherein the second link modification reject message is transmitted in unicast manner.

10. The method of claim 1, wherein the link modification reject message is transmitted in unicast manner.

11. A wireless transmit/receive unit (WTRU) comprising a processor, a transceiver unit and a storage unit, and configured to:
receive from each WTRU-to-WTRU relay of a first set of WTRU-to-WTRU relays, a direct communication request message including a first communication request from a first source WTRU;
receive from each WTRU-to-WTRU relay of a second set of WTRU-to-WTRU relays, a link modification request message including a second communication request from the first source WTRU;
select a WTRU-to-WTRU relay among the first and second sets of WTRU-to-WTRU relays for communication with the first source WTRU; and
transmit a link modification reject message to all WTRU-to-WTRU relays of the second set of WTRU-to-WTRU relays not selected for communication with the source WTRU, wherein the link modification reject message includes a first indication on that the WTRU-to-WTRU relays of the second set of WTRU-to-WTRU relays are not selected by the WTRU.

12. The WTRU of claim 11, configured to transmit a direct communication reject message to the selected WTRU-to-WTRU relay, on condition that the selected WTRU-to-WTRU relay is from the first set of WTRU-to-WTRU relays and an existing sidelink connection between the WTRU and the selected WTRU-to-WTRU relay is already established, wherein the direct communication reject message includes a second indication on that there is existing connection.

13. The WTRU of claim 12, configured to perform a link modification procedure with the selected WTRU-to-WTRU relay for modifying the existing sidelink connection.

14. The WTRU of claim 11, wherein the WTRU being configured to select a WTRU-to-WTRU relay comprises the WTRU being configured to select, among the first and second sets of WTRU-to-WTRU relays, a third set of WTRU-to-WTRU relays transmitting direct communication request message or link modification request message originated from a same source WTRU for a same ProSe services with the WTRU; and to select the WTRU-to-WTRU relay, from the third set of WTRU-to-WTRU relays, based on any of signal strength, local policy, and operator policy per relay service code.

15. The WTRU of claim 11, wherein the link modification reject message is a first link modification reject message, and wherein the WTRU is configured to transmit a direct communication accept message to the selected WTRU-to-WTRU relay and transmit a second link modification reject message to all WTRU-to-WTRU relays of the second set of WTRU-to-WTRU relays, on condition that the selected WTRU-to-WTRU relay is from the first set of WTRU-to-WTRU relays.

16. The WTRU of claim 11, wherein the direct communication request message and the link modification request message comprise information indicating any of proximity-based services, information on the source WTRU information and information on the WTRU.

17. The WTRU of claim 15, wherein the direct communication accept message is transmitted in a unicast manner.

18. The WTRU of claim 11, wherein the link modification request messages are message is transmitted in unicast manner.

19. The WTRU of claim 15, wherein the second link modification reject message is transmitted in unicast manner.

20. The WTRU of claim 11, wherein the link modification reject message is transmitted in unicast manner.
